(19) United States
(12) Patent Application Publication
(10) Pub. No.: US 2026/0131817 A1
(43) Pub. Date: May 14, 2026

(54) SYSTEM AND METHOD FOR DISPLAYING ALERT RELATED TO MOBILE DEVICE

(71) Applicants: HYUNDAI MOTOR COMPANY, Seoul (KR); Kia Corporation, Seoul (KR)

(72) Inventors: Jiankang MAN, Shandong (CN); Zhe LI, Shandong (CN); Hanghang WANG, Shandong (CN); Guofeng JIN, Shandong (CN)

(73) Assignees: HYUNDAI MOTOR COMPANY, Seoul (KR); Kia Corporation, Seoul (KR)

(21) Appl. No.: 19/386,000

(22) Filed: Nov. 11, 2025

(30) Foreign Application Priority Data
Nov. 13, 2024 (CN) 202411623957.1

(51) Int. Cl. B60W 50/14; B60K 35/28; B60W 40/08; B60W 50/10; G06V 40/12; G06V 40/16

(52) U.S. Cl. CPC B60W 50/14; B60K 35/28; B60W 40/08; B60W 50/10; G06V 40/1365; G06V 40/172; B60K 2360/56; B60K 2360/741; B60W 2040/0809; B60W 2050/143; B60W 2050/146; B60W 2420/403; B60W 2510/244; B60W 2540/043

(57) ABSTRACT

A system and a method for providing an alert based on mobile device detection are disclosed. The system includes a driving intention detector configured to detect whether a vehicle intends to drive, a passenger identifier configured to identify a passenger Identification (ID) of a vehicle passenger, a device ID detector configured to detect one or more device IDs of one or more mobile devices inside the vehicle, a device determiner configured to determine whether the detected one or more device IDs match the identified passenger ID of the vehicle passenger, based on the passenger ID of the vehicle passenger identified by the passenger identifier and the one or more device IDs of the one or more mobile devices inside the vehicle detected by the device ID detector, and a vehicle notifier configured to send the alert based on a determination that the one or more device IDs and the identified passenger ID of the vehicle passenger do not match after the vehicle is detected to be driving by the driving intention detector.

### CROSS-REFERENCE TO RELATED APPLICATION

This application claims priority to and the benefit of Chinese Patent Application No. 202411623957.1 filed at the Chinese National Intellectual Property Administration on Nov. 13, 2024, the entire contents of which are incorporated herein by reference.

### BACKGROUND OF THE DISCLOSURE

### (a) Field of the Disclosure

The present disclosure relates to a vehicle technology field, and more particularly, to a system and a method for displaying an alert related to a mobile device.

### (b) Description of the Related Art

Electronic devices are becoming increasingly mobile and portable.

A common example of a mobile or portable electronic device is a cell phone. More and more people are carrying cell phones. In particular, vehicle users who drive for travel are more dependent on their mobile phones.

If people leave their cell phones at home or at work instead of taking it with them, they will usually drive back to get it, even if the vehicle has already traveled a long distance.

However, there is currently no solution for the above case.

The above information disclosed in this Background section is provided only to facilitate understanding of the background of the present disclosure, and may therefore include information that is not a part of the prior art that would be already known to those skilled in the art to which the present disclosure pertains.

### SUMMARY OF THE DISCLOSURE

The present disclosure attempts to provides a system and a method for displaying an alert related to a mobile device that detects the mobile device inside a vehicle when the vehicle is about to drive, and sends the alert if no mobile device corresponding to a current vehicle passenger is detected.

According to an embodiment of the present disclosure, a system for displaying an alert related to a mobile device is provided. The system includes a driving intention detector configured to detect whether a vehicle intends to drive, a passenger identifier configured to identify a passenger ID of a vehicle passenger, a device ID detector configured to detect a device ID of a mobile device inside the vehicle, a device determiner configured to determine whether the device ID of the mobile device detected by the device ID detector matches the passenger ID of the vehicle passenger identified by the passenger identifier, based on the passenger ID of the vehicle passenger being identified by the passenger identifier and the device ID of the mobile device inside the vehicle being detected by the device ID detector, and a vehicle notifier configured to send the alert based on a device determiner determining that the device ID of the mobile device detected by the device ID detector and the passenger ID of the vehicle passenger identified by the passenger identifier do not match after the vehicle is detected to be driving by the driving intention detector.

The device determiner may be configured to pre-save the passenger ID, the device ID of the mobile device, and the correspondence between the passenger ID and the device ID of the mobile device, determine the device ID of the mobile device corresponding to the passenger ID of the vehicle passenger identified by the passenger identifier as a reference device ID according to the pre-saved correspondence, compare the device ID of the mobile device detected by the device ID detector with the reference device ID, and determine that a device ID of a mobile device detected by a device ID detector does not match a passenger ID of a vehicle passenger identified by the passenger identifier, based on the device ID of the mobile device detected by the device ID detector not including the reference device ID or including only a portion of the reference device IDs.

The vehicle notifier may be further configured to send the alert based on the device ID of the mobile device inside the vehicle not being detected by the device ID detector after the vehicle is detected to be driving by the driving intention detector.

The system may further include a device charging detector configured to detect whether the mobile device is in a charging state, wherein the vehicle notifier may be further configured to send a notification based on the mobile device being detected to be in a charging state by the device charging detector.

The driving intention detector may be configured to detect power status of the vehicle and detect that the vehicle intends to drive based on the power status of the vehicle being IGN ON or START.

The passenger identifier may be configured to identify the passenger ID of the vehicle passenger through fingerprint information of the passenger.

The passenger identifier may be configured to identify the passenger ID of the vehicle passenger through an image of the passenger's face.

The alert may be a generated voice or a displayed image.

According to another embodiment, a method for displaying an alert related to a mobile device is provided. The method includes detecting whether a vehicle intends to drive, identifying a passenger ID of a vehicle passenger, detecting a device ID of the mobile device inside the vehicle, determining whether the device ID of the detected mobile device matches the passenger ID of the identified vehicle passenger based on the passenger ID of the vehicle passenger being identified and the device ID of the mobile device inside the vehicle being detected, and sending the alert based on determining that the device ID of the detected mobile device and the passenger ID of the identified vehicle passenger do not match after the vehicle is detected to be driving.

The determining whether the device ID of the detected mobile device matches the passenger ID of the identified vehicle passenger may include pre-saving the passenger ID, the device ID of a mobile device, and correspondence between the passenger ID and the device ID of the mobile device, determining the device ID of the mobile device corresponding to the passenger ID of the identified vehicle passenger as a reference device ID according to the pre-saved correspondence, comparing the device ID of the detected mobile device with the reference device ID, and determining that the device ID of the detected mobile device does not match the passenger ID of the identified vehicle passenger based on the device ID of the detected mobile device not including the reference device ID or including only a portion of the reference device IDs.

The method may further include sending the alert based on the device ID of the mobile device inside the vehicle not being detected after the vehicle is detected to be driving.

The method may further include mobile detecting whether the mobile device is in a charging state, and sending a notification based on the mobile device being detected to be in a charging state.

The detecting whether a vehicle intends to drive may include detecting the power status of the vehicle, and detecting that the vehicle intends to drive based on the power status of the vehicle being IGN ON or START.

The identifying the passenger ID of the vehicle passenger may include identifying the passenger ID of the vehicle passenger through fingerprint information of the passenger.

The identifying the passenger ID of the vehicle passenger may include identifying the passenger ID of the vehicle passenger through an image of the passenger's face.

The alert may be a generated voice or displayed image.

According to an embodiment of the present disclosure, it is possible to detect the mobile device inside the vehicle when the vehicle intends to drive, and send the alert if the mobile device corresponding to the current vehicle passenger is not detected. This avoids the situation where vehicle users forget to bring their mobile devices and end up having to go back to retrieve the mobile devices.

In addition, any advantages which may be acquired or inferred from the embodiments of the present disclosure are directly or implicitly disclosed in the detailed description of the embodiment of the present disclosure. That is, various advantages inferred from the embodiments of the present disclosure are disclosed in the detailed description that follows.

### BRIEF DESCRIPTION OF THE DRAWINGS

Hereinafter, an embodiment of the present disclosure is described in more detail with reference to the accompanying drawings. For clarity of description, identical parts in different drawings are indicated using the same reference numerals. It should be noted that the drawings are illustrative only and are not necessarily drawn to scale.

FIG. 1 is a block diagram of a system for displaying an alert related to a mobile device according to an embodiment of the present disclosure.

FIG. 2 shows an example of a user interface of an audio, video, navigation, & telecommunication (AVNT) device.

FIG. 3 is a flowchart of a method for displaying an alert related to a mobile device according to an embodiment of the present disclosure.

### DETAILED DESCRIPTION OF THE EMBODIMENTS

Hereinafter, embodiments of the present disclosure will be described in detail. The present embodiment is implemented based on the technical solution of the present disclosure, and discloses a detailed implementation method and a specific operation process, but the scope of the present disclosure is not limited to the following embodiment.

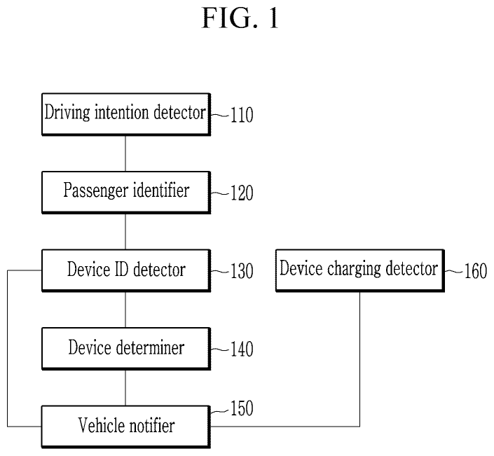

FIG. 1 is a block diagram of a system for displaying an alert related to a mobile device according to an embodiment of the present disclosure. As shown in FIG. 1, a system for displaying an alert related to a mobile device according to an embodiment of the present disclosure includes a driving intention detector 110, a passenger identifier 120, a device ID detector 130, a device determiner 140, a device charging detector 160, and a vehicle notifier 150. In some embodiments, according to an exemplary embodiment of the present disclosure, the system may include a processor (e.g., computer, microprocessor, CPU, ASIC, circuitry, logic circuits, etc.) and an associated non-transitory memory storing software instructions which, when executed by the processor, provides the functionalities of the driving intention detector 110, the passenger identifier 120, the device ID detector 130, the device determiner 140, the device charging detector 160, and the vehicle notifier 150. Herein, the memory and the processor may be implemented as separate semiconductor circuits. Alternatively, the memory and the processor may be implemented as a single integrated semiconductor circuit. The processor may embody one or more processor(s).

The driving intention detector 110 is configured to detect whether the vehicle intends to drive. Specifically, the driving intention detector 110 may be configured to detect the power status of the vehicle. The power status of the vehicle includes an ignition switch off (IGN OFF) state to turn off power to almost all vehicle-mounted devices, an accessory on (ACC ON) state to turn on power to some vehicle-mounted devices, an ignition switch on (IGN ON) state to turn on power to almost all vehicle-mounted devices, and a START state to start the engine or motor. Therefore, when the power status of the vehicle is IGN ON or START, the driving intention detector 110 may detect that the vehicle intends to drive. In addition, since the vehicle starting switch is a switch for switching the power status of the vehicle, the driving intention detector 110 may detect whether the vehicle intends to drive by receiving a signal generated when the starting switch is pressed.

After the vehicle is detected as intending to drive by the driving intention detector 110, the driving intention detector 110 may send information that the vehicle intends to drive to the passenger identifier 120. In other embodiments, the driving intention detector 110 may directly send information that the vehicle is intending to drive to the vehicle notifier 150.

The passenger identifier 120 is configured to identify a passenger identification (ID) of a vehicle passenger.

In an embodiment, the passenger identifier 120 may identify the passenger ID of the vehicle passenger through the passenger's fingerprint information. Specifically, the passenger identifier 120 may include a fingerprint identification module and a fingerprint authentication module. Fingerprint identification modules may be installed on each door handle. When a vehicle user attempts to open a door and board a vehicle by operating a door handle, the fingerprint identification module may collect the vehicle user's fingerprint information and send the collected fingerprint information to the fingerprint authentication module. Additionally, the fingerprint identification module may be installed in the vehicle starting switch. When the driver presses the starting switch to start the vehicle, the fingerprint identification module may collect the driver's fingerprint information. The fingerprint authentication module stores the passenger ID, the fingerprint information, and the correspondence between the passenger ID and fingerprint information in advance. The fingerprint authentication module may identify the passenger ID of the vehicle passenger by comparing the received fingerprint information with pre-saved fingerprint information and determining the passenger ID that matches the received fingerprint information.

In another embodiment, the passenger identifier 120 may identify the passenger ID of the vehicle passenger through an image of the passenger's face. Specifically, the passenger identifier 120 may include a camera and an image identification module. In one example, a camera may be installed on the inside rearview mirror to collect facial images of all passengers inside the vehicle (including those in the driver's seat, front passenger seat, and rear passenger seats). The camera sends the collected facial images to the image identification module. Similarly, the image identification module pre-saves the passenger ID, the facial image, and the correspondence between the passenger ID and the facial image. The image authentication module may identify the passenger ID of the vehicle passenger by comparing the received facial image with a pre-saved facial image and determining the passenger ID that matches the received facial image.

Additionally, the passenger identifier 120 may identify the passenger ID of the vehicle passenger by using fingerprint information and facial image in combination.

The passenger identifier 120 may collect fingerprint information and/or facial images of the vehicle passenger, receive information that the vehicle intends to drive from the driving intention detector 110, and then identify the passenger ID of the vehicle passenger based on the collected fingerprint information and/or facial image. In other embodiments, the passenger identifier 120 may identify the passenger ID of the vehicle passenger based on collected fingerprint information and/or facial image even if the passenger identifier 120 has not received information from the driving intention detector 110 that the vehicle intends to drive.

The device ID detector 130 is configured to detect the device ID of the mobile device inside the vehicle.

Specifically, the device ID detector 130 may be implemented by an audio, video, navigation, & telecommunication (AVNT) device. When the mobile device of the vehicle passenger is present inside the vehicle, the AVNT device may automatically establish a wireless communication connection with the mobile device of the vehicle passenger through a wireless communication function such as Bluetooth and detect the device ID of the mobile device.

The passenger identifier 120 may send the passenger ID of the identified vehicle passenger to the device ID detector 130, and the device ID detector 130 receives the passenger ID of the vehicle passenger from the passenger identifier 120, then detects the device ID of the mobile device inside the vehicle, and sends the received passenger ID of the vehicle passenger and the device ID of the detected mobile device inside the vehicle to the device determiner 140.

In other embodiments, the passenger identifier 120 may directly send the passenger ID of the identified vehicle passenger to the device determiner 140, and the device ID detector 130 may detect the device ID of the mobile device inside the vehicle and send the device ID of the detected mobile device inside the vehicle to the device determiner 140 even if the passenger ID of the vehicle passenger is not received from the passenger identifier 120.

If the device ID of the mobile device inside the vehicle is not detected by the device ID detector 130, information that there is no mobile device inside the vehicle is sent to the vehicle notifier 150, which will be described later.

The device determiner 140 is configured to determine whether the device ID of the mobile device detected by the device ID detector 130 matches the passenger ID of the vehicle passenger identified by the passenger identifier 120, after the passenger ID of the vehicle passenger is identified by the passenger identifier 120 and the device ID of the mobile device inside the vehicle being detected by the device ID detector 130.

Specifically, the device determiner 140 may pre-save the passenger ID, the device ID of the mobile device, and the correspondence between the passenger ID and the device ID of the mobile device. Table 1 shows an example of correspondence between the passenger ID and the device ID of the mobile device.

TABLE 1

| Device ID of mobile device | Passenger ID |
|---|---|
| Device ID A | Passenger ID A |
| Device ID B | Passenger ID B |
| Device ID C | Passenger ID C |
| Device ID D | Passenger ID D |
| Device ID E | Passenger ID E |

As shown in Table 1, the device determiner 140 may store passenger IDs (passenger ID A, passenger ID B, passenger ID C, passenger ID D, and passenger ID E) in advance. The device determiner 140 may store the device IDs (device ID A, device ID B, device ID C, device ID D, and device ID E) of the mobile device in advance. Additionally, the device determiner 140 may store the correspondence between the passenger ID and the device ID of the mobile device (passenger ID A corresponds to device ID A, passenger ID B corresponds to device ID B, passenger ID C corresponds to device ID C, passenger ID D corresponds to device ID D, and passenger ID E corresponds to device ID E) in advance.

Table 2 shows another example of the correspondence between the passenger ID and the device ID of the mobile device.

TABLE 2

| Device ID of mobile device | Passenger ID |
|---|---|
| Device ID A1 | Passenger ID A |
| Device ID A2 | |
| Device ID B | Passenger ID B |
| Device ID C | Passenger ID C |
| Device ID D | Passenger ID D |

Unlike Table 1, where one passenger ID corresponds to one device ID, in Table 2, passenger ID A corresponds to device ID A1 and device ID A2. In other words, one passenger ID may correspond to two or more device IDs.

The device determiner 140 may determine the device ID of the mobile device corresponding to the passenger ID of the vehicle passenger identified by the passenger identifier 120 as the reference device ID according to the pre-saved correspondence. For example, if the passenger ID of the vehicle passenger is identified as passenger ID A by the passenger identifier 120, the device determiner 140 may determine device ID A as the reference device ID according to the correspondence shown in Table 1. According to the correspondence shown in Table 2, the device determiner 140 may determine device ID A1 and device ID A2 as reference device IDs.

The device determiner 140 compares the device ID of the mobile device detected by the device ID detector 130 with the reference device ID.

If the device ID of the mobile device detected by the device ID detector 130 does not include the reference device ID or includes a portion of the reference device ID, the device determiner 140 may determine that the device ID of the mobile device detected by the device ID detector 130 and the passenger ID of the vehicle passenger identified by the passenger identifier 120 do not match.

According to the above example, if the device determiner 140 determines device ID A as the reference device ID, and if the device ID (e.g., device ID F and device ID G) of the mobile device detected by the device ID detector 130 does not include device ID A, the device determiner 140 may determine that the device ID of the mobile device detected by the device ID detector 130 and the passenger ID of the vehicle passenger identified by the passenger identifier 120 do not match.

If the device determiner 140 determines device ID A1 and device ID A2 as the reference device IDs, and the device IDs (e.g., device ID F and device ID G) of the mobile device detected by the device ID detector 130 do not include device ID A1 and device ID A2, or if the device IDs (e.g., device ID F and device ID A1) of the mobile device detected by the device ID detector 130 include only one of device ID A1 and device ID A2 (i.e., device ID A1), the device determiner 140 may determine that the device ID of the mobile device detected by the device ID detector 130 and the passenger ID of the vehicle passenger identified by the passenger identifier 120 do not match.

An embodiment of the present disclosure may also be applied to a case where the passenger IDs of two or more vehicle passengers are identified by the passenger identifier 120. When the passenger IDs of the vehicle passengers are identified as passenger ID A and passenger ID D by the passenger identifier 120, and the device determiner 140 determines device ID A1, device ID A2, and device ID D as reference device IDs according to the correspondence shown in Table 2, if the device IDs of the mobile device detected by the device ID detector 130 (e.g., device ID F and device ID G) do not include device ID A1, device ID A2, and device ID D, or if the device IDs of the mobile device detected by the device ID detector 130 (e.g., device ID D and device ID A1) include only some of device ID A1, device ID A2, and device ID D (i.e., device ID A1 and device ID D), the device determiner 140 may determine that the device IDs of the mobile device detected by the device ID detector 130 and the passenger IDs of the vehicle passengers identified by the passenger identifier 120 do not match.

Conversely, if the device ID of the mobile device detected by the device ID detector 130 includes the entirety of the reference device ID, the device determiner 140 may determine that the device ID of the mobile device detected by the device ID detector 130 and the passenger ID of the vehicle passenger identified by the passenger identifier 120 match.

Thereafter, the device determiner 140 may send the matching or non-matching result information to the vehicle notifier 150.

Specifically, the device determiner 140 may be implemented through the AVNT device. The AVNT device has a user interface for vehicle user input, and the vehicle user may input and save the device ID of the mobile device, the passenger ID, and the correspondence between the passenger ID and the device ID of the mobile device into the AVNT device through the user interface.

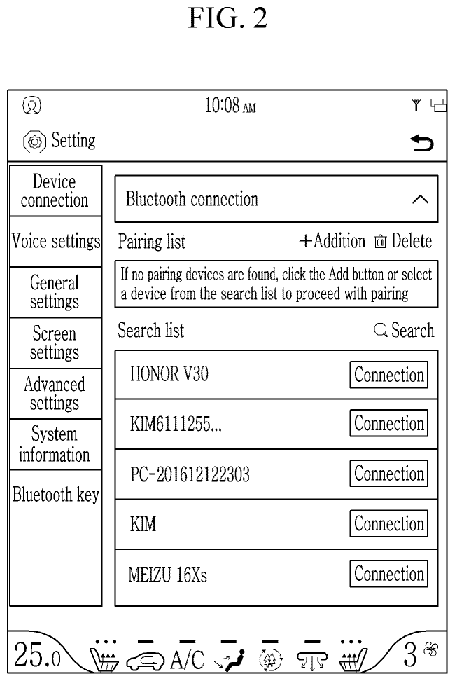

FIG. 2 shows an example of a user interface of an audio, video, navigation & telecommunication (AVNT) device. The AVNT device may be a hardware device implemented by various electronic circuits (e.g., computer, microprocessor, CPU, ASIC, circuitry, logic circuits, etc.). The AVNT device may be implemented by a processor and a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s). As shown in FIG. 2, a vehicle user may wirelessly communicate with each of a plurality of mobile devices to the AVNT device, save the device ID of each mobile device in the AVNT, and display the names of each of the plurality of mobile devices in the left column of the “Search List” of the user interface. Further, vehicle users may arrange the names of mobile devices in order based on the frequency with which the mobile device user rides in the vehicle. Vehicle users may click the “Connect” button in the right column and enter the passenger ID corresponding to the mobile device on the left. Therefore, the vehicle user may input the passenger ID and the correspondence between the passenger ID and the device ID of the mobile device into the AVNT device.

After pre-saving information entered by the vehicle user in the AVNT device, the AVNT device may determine whether the device ID of the mobile device detected by the device ID detector 130 and the passenger ID of the vehicle passenger identified by the passenger identifier 120 match.

Additionally, the vehicle user may select only one of the input mobile devices as an alert target through the user interface of the AVNT device, or, if one passenger ID corresponds to two or more mobile devices, select only the last input mobile device as an alert target, or implement a function to send an alert according to the order of the input mobile devices.

The vehicle notifier 150 is configured to send an alarm when the device determiner 140 determines that the device ID of the mobile device detected by the device ID detector 130 and the passenger ID of the vehicle passenger identified by the passenger identifier 120 do not match after the vehicle intention detector 110 detects that the vehicle intends to drive. Here, the alert may be sent by voice generation or image display.

Specifically, the vehicle notifier 150 may be a cluster panel, the AVNT device, or a combination of the cluster panel and the AVNT device. The vehicle notifier 150 may display an image, which may include an alert message indicating that a specific mobile device is not present in the vehicle. The vehicle notifier 150 may also send an alarm sound. Additionally, the vehicle user may select whether to activate an image alert and/or voice alert on the cluster panel through the user interface of the AVNT device. After the vehicle notifier 150 sends an alert, the vehicle user may cancel the alert through the user interface of the AVNT device.

In addition to cases where it is determined that the device ID of the mobile device detected by the device ID detector 150 and the passenger ID of the vehicle passenger identified by the passenger identifier 120 do not match, there are cases where the device ID of the mobile device inside the vehicle is not detected by the device ID detector 130. According to an embodiment of the present disclosure, after the driving intention detector 110 detects that the vehicle intends to drive, if the device ID of the mobile device inside the vehicle is not detected by the device ID detector 130, the vehicle notifier 150 may send an alert without the device determiner 140 needing to perform a determination regarding matching. That is, if the vehicle intends to drive and there is at least one driver inside the vehicle, and there is no mobile device inside the vehicle, the vehicle notifier 150 may send an alert.

In the related art, a vehicle device is provided with a charging device for a mobile device. If the charging device is a wireless charging device, the charging device is based on a wireless power consortium (WPC) protocol, and when the mobile device and the wireless charging device are inductively coupled, the charging device may charge the mobile device. If the charging device is a wired charging device, the charging part is a charging plug such as a universal serial bus (USB) connector, and when the charging plug is connected to the charging interface of the mobile device, the charging device may charge the mobile device.

When the mobile device is charged through the charging device in an OFF state, the device ID detector 130 cannot detect the mobile device due to the OFF state of the mobile device, and thus the vehicle notifier 150 may mislead the vehicle user by sending an alarm that the mobile device is not in the vehicle.

To preclude the above problem, the device charging detector 160 may be configured to detect whether the mobile device is in a charging state. Specifically, the device charging detector 160 may detect whether the charging plug on the vehicle is connected to the charging interface of the mobile device or whether the wireless charging device is inductively coupled with the mobile device.

When the device charging detector 160 detects that the mobile device is in the charging state, the device charging detector 160 may send information that the mobile device is in the charging state to the vehicle notifier 150, and the vehicle notifier 150 may send a notification. For example, a cluster panel, AVNT device, etc. may display an image, and the image may include a notification message indicating that a particular mobile device is charging.

According to another embodiment of the present disclosure, a method for displaying an alert related to a mobile device is provided.

The method for displaying the alert related to the mobile device according to an embodiment includes detecting whether a vehicle intends to drive, identifying a passenger ID of a vehicle passenger, detecting a device ID of the mobile device inside the vehicle, determining whether the device ID of the detected mobile device matches the passenger ID of the identified vehicle passenger based on the passenger ID of the vehicle passenger being identified and the device ID of the mobile device inside the vehicle being detected, and sending an alert based on determining that the device ID of the detected mobile device and the passenger ID of the identified vehicle passenger do not match after the vehicle is detected to drive.

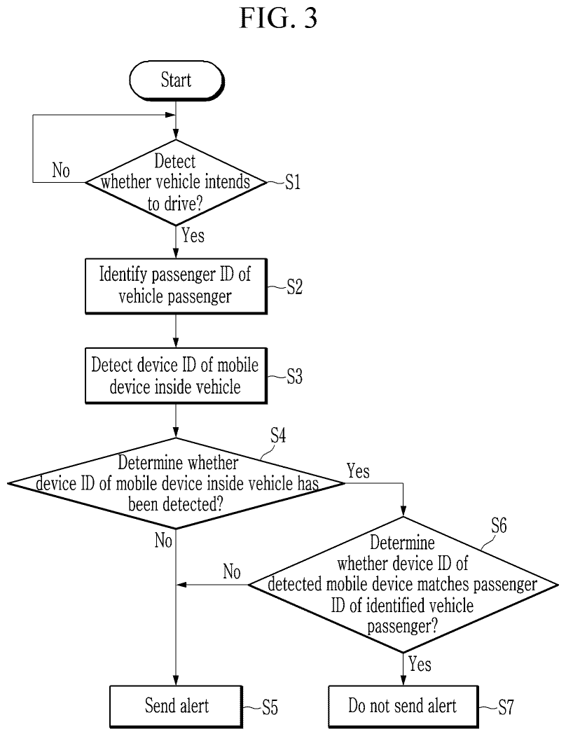

FIG. 3 is a flowchart of a method for displaying an alert related to a mobile device according to an embodiment of the present disclosure. As shown in FIG. 3, whether the vehicle intends to drive is detected (S1). Specifically, the step of detecting whether the vehicle intends to drive includes a step of detecting the power status of the vehicle, and a step of detecting that the vehicle intends to drive when the power status of the vehicle is IGN ON or START.

After detecting that the vehicle intends to drive (“Yes” in step (S1)), the passenger ID of the vehicle passenger is identified (S2). Specifically, in an embodiment, step (S2) of identifying the passenger ID of the vehicle passenger includes a step of identifying the passenger ID of the vehicle passenger through fingerprint information of the passenger. In another embodiment, step (S2) of identifying the passenger ID of the vehicle passenger includes a step of identifying the passenger ID of the vehicle passenger through an image of the passenger's face.

After identifying the passenger ID of the vehicle passenger (S2), the device ID of the mobile device inside the vehicle is detected (S3).

After detecting the device ID of the mobile device inside the vehicle (S3), it is determined whether the device ID of the mobile device inside the vehicle has been detected (S4).

If the device ID of the mobile device inside the vehicle is not detected (“No” in step (S4)), an alert is sent (S5). Specifically, the alert may be a generated voice or a displayed image.

When the device ID of the mobile device inside the vehicle is detected (“Yes” in step (S4)), it is determined whether the device ID of the detected mobile device matches the passenger ID of the identified vehicle passenger (S6).

If it is determined that the device ID of the detected mobile device matches the passenger ID of the identified vehicle passenger (“Yes” in step (S6)), no alert is sent (S7).

If it is determined that the device ID of the detected mobile device does not match the passenger ID of the identified vehicle passenger (“No” in (S7)), an alarm is sent (S5).

Specifically, determining whether the device ID of the detected mobile device matches the passenger ID of the identified vehicle passenger may include pre-saving the passenger ID, the device ID of a mobile device, and a correspondence between the passenger ID and the device ID of the mobile device, determining the device ID of the mobile device corresponding to the passenger ID of the identified vehicle passenger as a reference device ID according to a pre-saved correspondence, comparing the device ID of the detected mobile device with the reference device ID, and determining that the device ID of the detected mobile device does not match the passenger ID of the identified vehicle passenger based on the device ID of the detected mobile device not including the reference device ID or including a portion of the reference device ID.

As shown in FIG. 3, step (S2) is executed after step (S1), and steps (S3) and (S4) are executed after step (S2), but the embodiment of the present disclosure is not limited thereto. Step (S1) may be performed in the same order as step (S2), or steps (S1) and (S2) may be performed simultaneously. That is, the embodiment of the present disclosure does not limit the order between the step of detecting whether the vehicle intends to drive and the step of identifying the passenger ID of the vehicle passenger. Additionally, steps (S3) and (S4) may be performed in a reversed order with the step (S2). That is, after it is detected that the vehicle intends to drive (“Yes” in step (S1)), the device ID of the mobile device inside the vehicle may be detected first (“Yes” in step (S4)), and after the device ID of the mobile device inside the vehicle is detected (“Yes” in step (S4)), the passenger ID of the vehicle passenger may be identified (S3). Alternatively, steps (S3) and (S4) and the step (S2) may be performed simultaneously.

According to an embodiment of the present disclosure, the method for displaying the alert related to the mobile device may further include the step of detecting whether the mobile device is in the charging state, and sending a notification if the mobile device is detected to be in the charging state.

The system and method for displaying the alert related to the mobile device according to an embodiment of the present disclosure may detect the mobile device inside the vehicle when the vehicle intends to drive, and send an alert if the mobile device corresponding to a current vehicle passenger is not detected. This precludes the situation where vehicle users forget to bring their mobile devices and end up having to go back to retrieve the mobile devices.

The various embodiments of the present disclosure do not enumerate all possible combinations, but rather describe representative aspects of the present disclosure, and furthermore, the contents described in the various embodiments may be applied independently or in a combination of two or more.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A system for providing an alert based on mobile device detection, comprising:
a driving intention detector configured to detect whether a vehicle intends to drive;
a passenger identifier configured to identify a passenger Identification (ID) of a vehicle passenger;
a device ID detector configured to detect one or more device IDs of one or more mobile devices inside the vehicle;
a device determiner configured to determine whether the detected one or more device IDs match the identified passenger ID of the vehicle passenger, based on the passenger ID of the vehicle passenger identified by the passenger identifier and the one or more device IDs of the one or more mobile devices inside the vehicle detected by the device ID detector; and
a vehicle notifier configured to send the alert via a user interface based on a determination that the one or more device IDs and the identified passenger ID of the vehicle passenger do not match after the vehicle is detected to be driving by the driving intention detector.

2. The system of claim 1, wherein the device determiner is configured to:
store an associated passenger ID of a vehicle passenger related to the vehicle, one or more device IDs of one or more mobile devices associated with the vehicle passenger related to the vehicle, and correspondence information between the associated passenger ID and the one or more device IDs;
determine whether the identified passenger ID of the vehicle passenger corresponds to at least one device ID based on the correspondence information, and determine the at least one device ID as at least one reference device ID based on a determination that the passenger ID of the vehicle passenger identified by the passenger identifier corresponds to the at least one device ID;
compare the detected one or more device IDs with the at least one reference device ID; and
determine that the detected one or more device IDs does not match the identified passenger ID of the vehicle passenger, based on a comparison result that the one or more device IDs does not include the at least one reference device ID, or the one or more device IDs partially overlaps with the at least one reference device ID.

3. The system of claim 1, wherein the vehicle notifier is further configured to send the alert based on the one or more device IDs of the one or more mobile devices inside the vehicle not being detected by the device ID detector after the vehicle is detected to be driving by the driving intention detector.

4. The system of claim 1, further comprising:
a device charging detector configured to detect whether at least one of the one or more mobile devices is in a charging state,
wherein the vehicle notifier is further configured to send a notification based on a detection that the at least one of the one or more mobile devices is in the charging state.

5. The system of claim 1, wherein the driving intention detector is configured to detect power status of the vehicle and detect that the vehicle intends to drive based on the power status of the vehicle being IGN ON or START.

6. The system of claim 1, wherein the passenger identifier is configured to identify the passenger ID of the vehicle passenger through fingerprint information of the vehicle passenger.

7. The system of claim 1, wherein the passenger identifier is configured to identify the passenger ID of the vehicle passenger through an image of the vehicle passenger's face.

8. The system of claim 1, wherein the alert includes a generated voice or a displayed image.

9. A method for providing an alert based on mobile device detection, comprising:
detecting whether a vehicle intends to drive;
identifying a passenger Identification (ID) of a vehicle passenger;
detecting one or more device IDs of one or more mobile devices inside the vehicle;
determining whether the detected one or more device IDs match the identified passenger ID of the vehicle passenger based on the passenger ID of the vehicle passenger identified and the one or more device IDs of the one or more mobile devices inside the vehicle detected; and
sending the alert via a user interface based on a determination that the one or more device IDs and the identified passenger ID of the vehicle passenger do not match after the vehicle is detected to be driving.

10. The method of claim 9, wherein determining whether the detected one or more device IDs match the identified passenger ID of the vehicle passenger comprises:
storing an associated passenger ID of a vehicle passenger related to the vehicle, one or more device IDs of one or more mobile devices associated with the vehicle passenger related to the vehicle, and correspondence information between the associated passenger ID and the one or more device IDs;
determining whether the identified passenger ID of the vehicle passenger corresponds to at least one device ID based on the correspondence information, and determine the at least one device ID as at least one reference device ID based on a determination that the passenger ID of the vehicle passenger identified by the passenger identifier corresponds to the at least one device ID;
comparing the detected one or more device IDs with the at least one reference device ID; and
determining that the detected one or more device IDs does not match the identified passenger ID of the vehicle passenger, based on a comparison result that the one or more device IDs does not include the at least one reference device ID, or the one or more device IDs partially overlaps with the at least one reference device ID.

11. The method of claim 9, further comprising:
sending the alert based on the one or more device IDs of the one or more mobile devices inside the vehicle not being detected after the vehicle is detected to be driving.

12. The method of claim 9, further comprising:
detecting whether at least one of the one or more mobile devices is in a charging state; and
sending a notification based on a detection that the at least one of the one or more mobile devices is detected to be in the charging state.

13. The method of claim 9, wherein the detecting whether the vehicle intends to drive comprises:
detecting power status of the vehicle; and
detecting that the vehicle intends to drive based on the power status of the vehicle being IGN ON or START.

14. The method of claim 9, wherein the identifying the passenger ID of the vehicle passenger comprises identifying the passenger ID of the vehicle passenger through fingerprint information of the vehicle passenger.

15. The method of claim 9, wherein the identifying the passenger ID of the vehicle passenger comprises identifying the passenger ID of the vehicle passenger through an image of the vehicle passenger's face.

16. The method of claim 9, wherein the alert includes a generated voice or displayed image.

17. The system of claim 1, the system comprising:
a processor that configures the user interface including a list of a plurality of mobile devices, wherein the plurality of mobile devices is associated with a plurality of vehicle passengers related to the vehicle,
wherein the processor rearranges the list of the plurality mobile devices based on a frequency with which the plurality of vehicle passengers ride in the vehicle.

18. The method of claim 9, the method comprising:
configuring the user interface including a list of a plurality of mobile devices, wherein the plurality of mobile devices is associated with a plurality of vehicle passengers related to the vehicle; and
rearranging the list of the plurality mobile devices based on a frequency with which the plurality of vehicle passengers ride in the vehicle.
